(19) United States
(12) Patent Application Publication
(10) Pub. No.: US 2025/0219507 A1
(43) Pub. Date: Jul. 3, 2025

(54) STATOR SEALINGS FOR ELECTRIC MOTOR COOLING SYSTEMS

(71) Applicant: Dana Automotive Systems Group, LLC, Maumee, OH (US)

(72) Inventors: John BRUZEWSKI, Buchanan, TN (US); Christopher M. COOK, McKenzie, TN (US); Matthew K. PASCHALL, Medina, TN (US); Brian BISHOP, Paris, TN (US); Randy MATHIS, Paris, TN (US); Jason WIMBERLEY, Paris, TN (US); Dakota FOSTER, Paris, TN (US); Michael Kevin NANNEY, Paris, TN (US)

(21) Appl. No.: 18/984,037

(22) Filed: Dec. 17, 2024

Related U.S. Application Data
(60) Provisional application No. 63/616,263, filed on Dec. 29, 2023.

(51) Int. Cl. H02K 9/197

(52) U.S. Cl. CPC H02K 9/197

(57) ABSTRACT

Stator sealing systems are disclosed herein for sealing coolant fluid that cools a stator from entering a rotor cavity within a bore of the stator. The stator sealing system includes sealing rings positioned at sealing interfaces at both ends of the stator provided by either bend lamination layers on both ends of the stator or a bore sleeve positioned in the bore.

### CROSS REFERENCE TO RELATED APPLICATIONS

The present application claims priority to U.S. Provisional Application No. 63/616,263 entitled “STATOR SEALINGS FOR ELECTRIC MOTOR COOLING SYSTEMS”, filed Dec. 29, 2023. The entire content of the above application is hereby incorporated by reference for all purposes.

### TECHNICAL FIELD

The present description relates generally to stator sealing for electric motors with cooling systems.

### BACKGROUND AND SUMMARY

Cooling of electric motors in electric vehicle applications has been implemented to achieve greater motor efficiency. In certain applications, stator windings that extend through a stator may be immersed in fluid, such as coolant fluid, as part of the cooling system. However, fluid in prior electric motor cooling systems can leak into a rotor cavity surrounded by the stator where a rotor is positioned. Fluid present within the rotor cavity may cause drag losses on rotation of the rotor, which may in turn reduce energy efficiency of the motor. Previous stator sealing designs, such as adhering sealing rings directly to the stator, may allow coolant fluid to leak, for example through the adhesive used to couple the sealing rings to the stator.

The inventors herein have developed stator cooling systems with alternative stator sealing methods to address at least some of the abovementioned problems. The stator sealing system of the present disclosure may extend the bore of the stator core beyond the lamination layers thereof to provide sealing interfaces where sealing rings may be positioned. The sealing interfaces may allow for more effective seals (e.g., seals less prone to leakage) to form between the interior and exterior of the rotor cavity. In one example, a laminated stator may include bend lamination layers wherein cylindrical protruding portions extend axially beyond the stator core at both ends to provide sealing interfaces where sealing rings may be positioned and separate fluid reservoirs from the rotor cavity. In another example, a bore sleeve with a longer axial length than the stator core may be placed in a rotor cavity of a laminated stator to provide sealing interfaces where sealing rings may be positioned. The combination of either lamination bends or a bore sleeve and sealing rings may provide greater leak protection compared to other stator sealing means, thereby increasing motor efficiency.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an electric motor with a cooling system and stator sealing system.

FIG. 2 shows a cross-sectional view of the electric motor depicted in FIG. 1 with a first example of the stator sealing system.

FIG. 3 shows a cross-sectional view of the electric motor depicted in FIG. 1 with a second example of the stator sealing system.

FIGS. 4A and 4B show a first view and a second view of a bend lamination layer of the first example depicted in FIG. 2.

FIGS. 5A and 5B show a first view and a second view of a bore sleeve of the second example depicted in FIG. 3.

FIG. 6 shows a lamination layer of a stator of the motor depicted in FIGS. 1-3.

FIG. 7 shows the bore sleeve with support rings.

FIG. 8 shows a cross-sectional view of the electric motor with the bore sleeve and the support rings.

### DETAILED DESCRIPTION

A stator assembly including a stator sealing system is described herein for immersion cooling systems that enable an electric motor to achieve an increased efficiency. The stator assembly may include a laminated stator core defining (e.g., circumferentially surrounding) a bore. In one example, the stator assembly includes bend lamination layers. In another example, the stator assembly includes a bore sleeve. The bend lamination layers or bore sleeve may protrude axially beyond the stator core to extend the stator bore, allowing sealing rings to be positioned thereon to form a sealed cavity around stator windings. In this way, the interior and exterior of a rotor cavity (e.g., space within the bore) wherein the rotor is positioned may be sealed from each other. The sealed cavities enable coolant (e.g., oil) to be directed through the stator and around windings thereof while preventing the coolant from entering the rotor cavity. As a result, drag losses caused by coolant in an air gap of the rotor cavity may be reduced (e.g., avoided), consequently increasing efficiency of the motor (e.g., output energy compared to input).

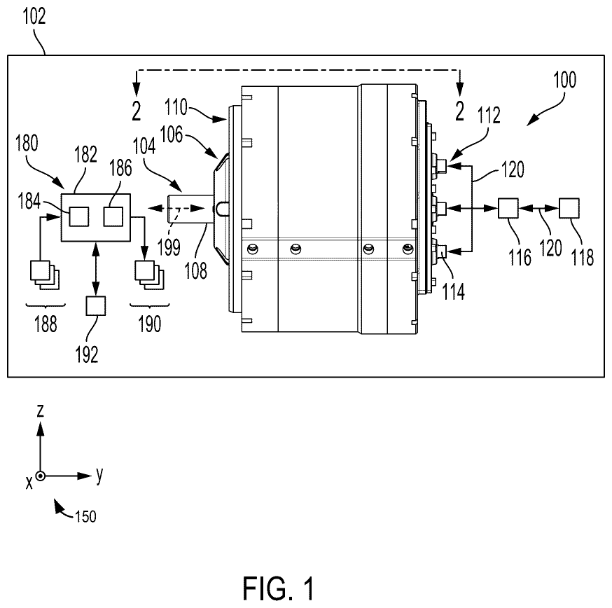

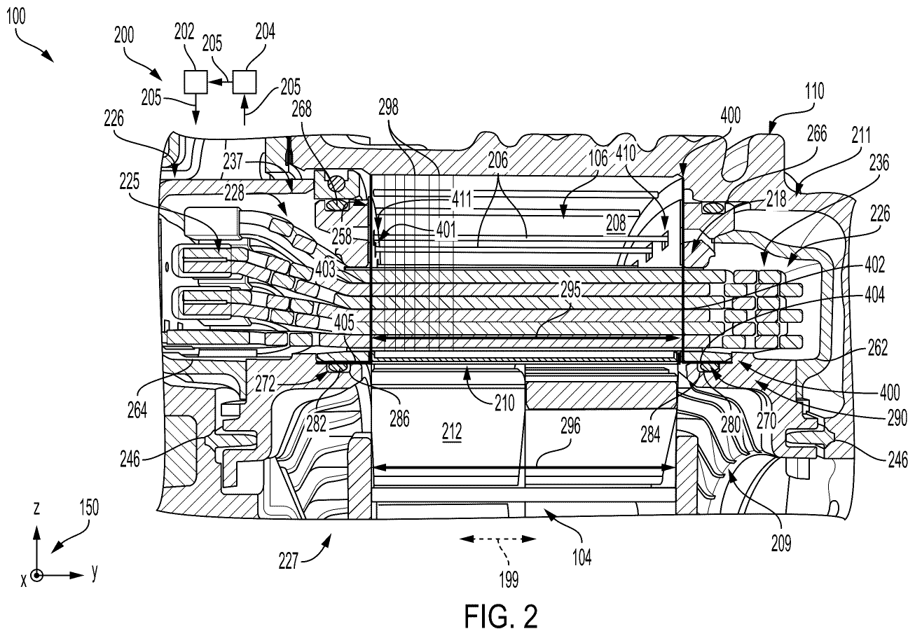

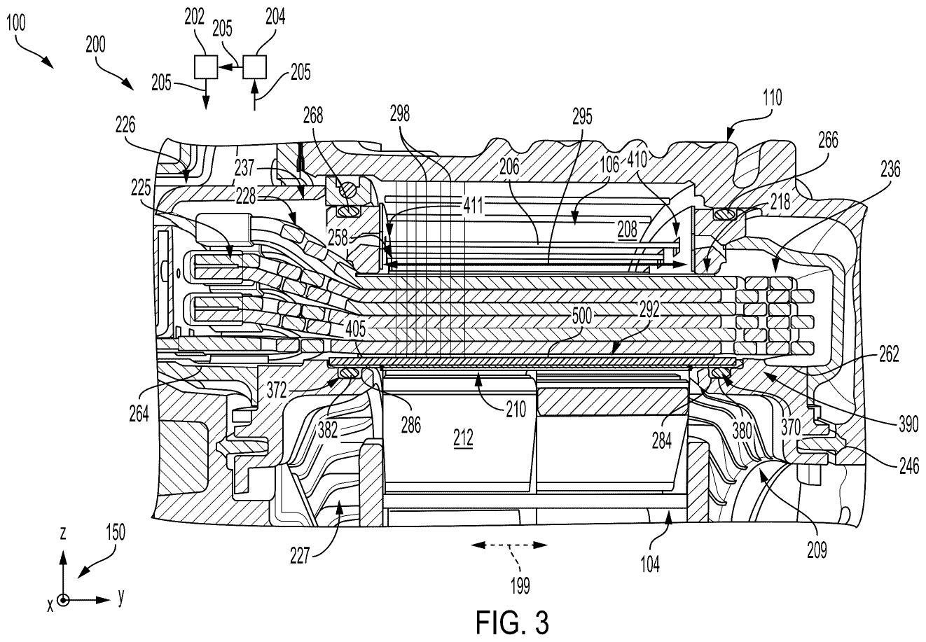

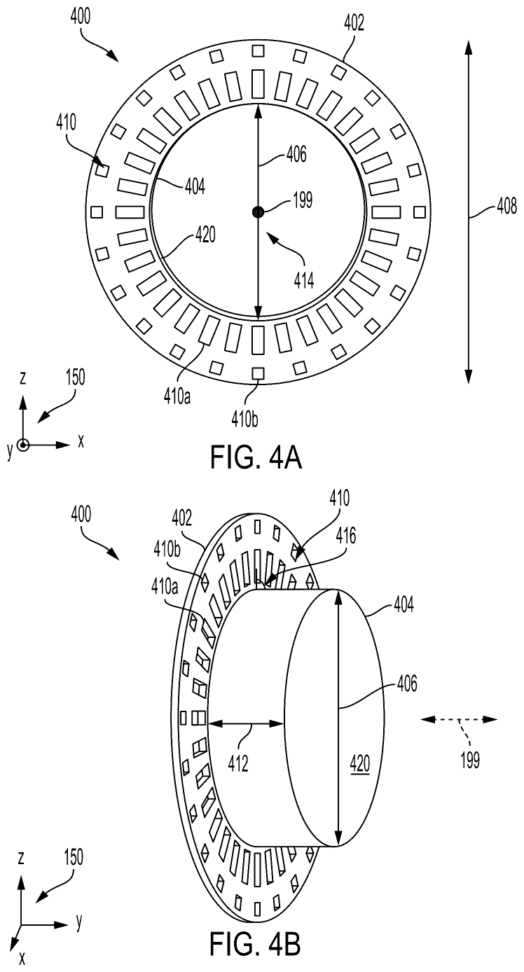

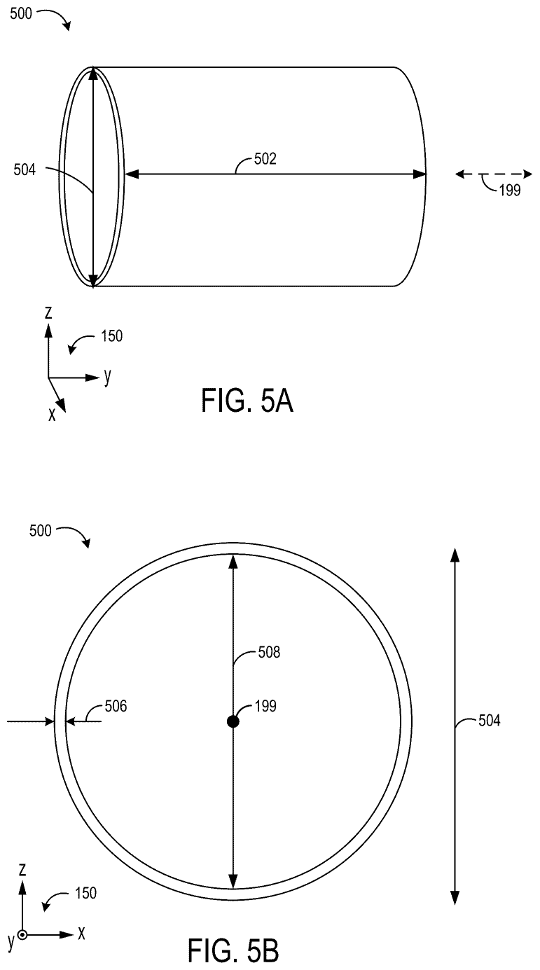

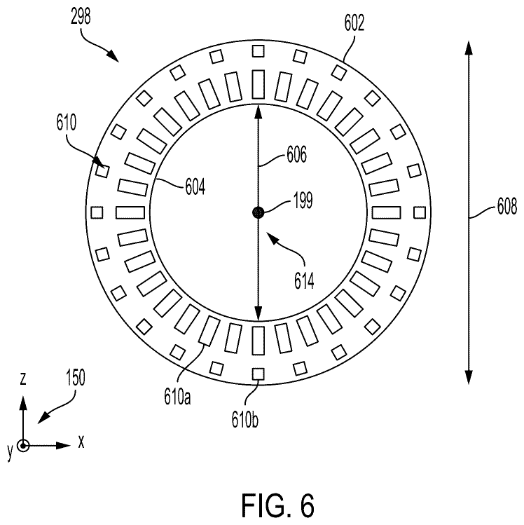

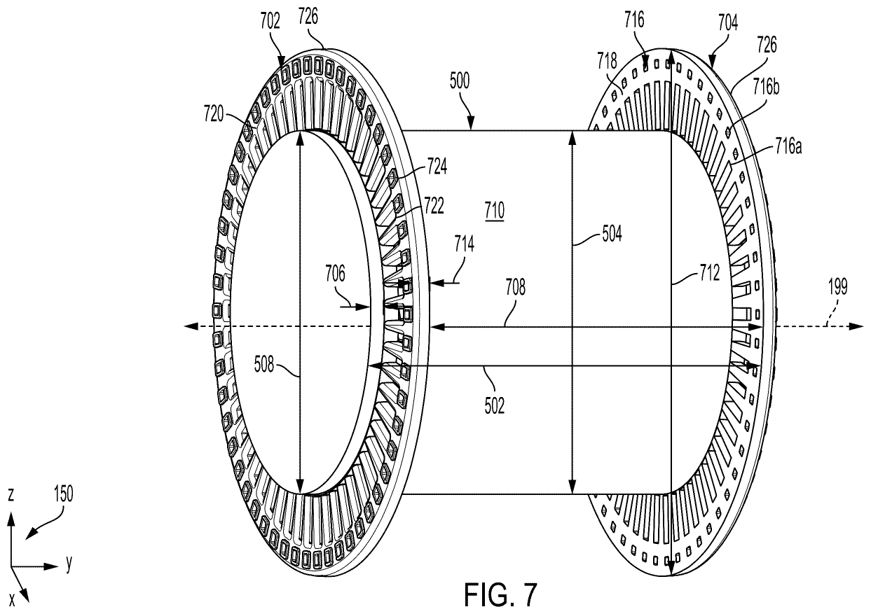

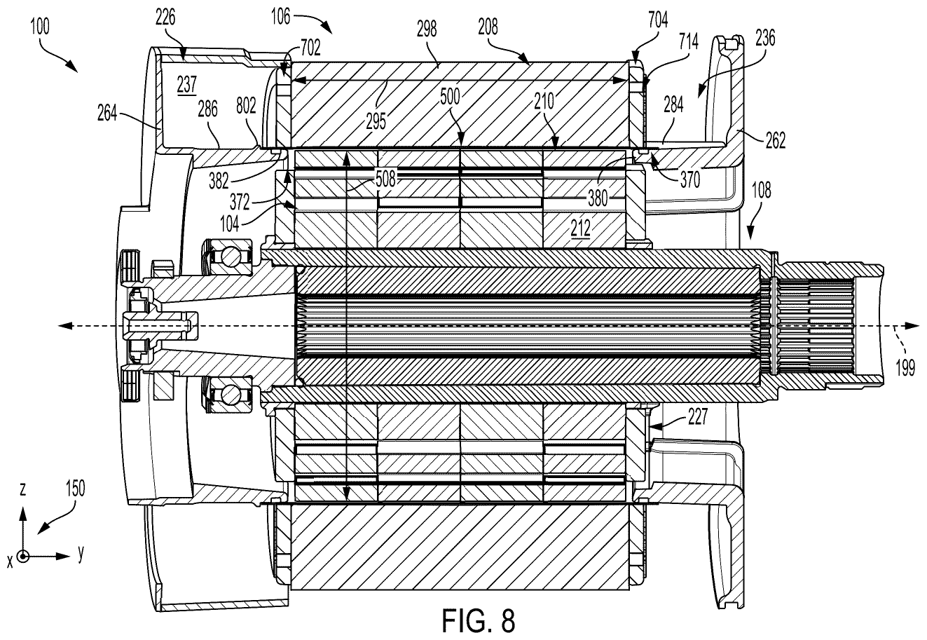

FIG. 1 shows an example of an electric motor which may include a cooling system and stator sealing system such as the stator sealing system described herein. FIG. 6 shows one of the lamination layers that makes up a stator core of the motor in FIG. 1. FIGS. 2 and 3 show cross sections of the motor shown in FIG. 1 with two examples of stator sealing systems, including bend lamination layers and a bore sleeve, respectively. FIGS. 4A and 4B show different views of the bend lamination layer of FIG. 2. FIGS. 5A and 5B show different views of the bore sleeve of FIG. 3. The bore sleeve is further shown in FIG. 7 with support rings, which may be included in a stator sealing system of the present disclosure. Part of the electric motor comprising the bore sleeve and support rings is shown in another view in FIG. 8.

FIG. 1 shows an illustration of an electric motor 100. Reference axes 150 are provided in FIG. 1, as well as FIGS. 2-8. The z-axis may be a vertical axis (e.g., parallel to a gravitational axis), the x-axis may be a lateral axis (e.g., horizontal axis), and/or the y-axis may be a longitudinal axis, in one example. Additionally or alternatively, the y-axis may be parallel to an axial direction with respect to the stator, while the z-axis and x-axis may be parallel to radial directions with respect to the stator. However, the axes may have other orientations, in other examples. Rotational axis 199 of the electric motor 100 is further provided for reference in FIG. 1 as well as FIGS. 2-8.

The electric motor 100 may be designed as an electric motor-generator and may be included in a system 102 which may take a variety forms. For instance, the electric motor 100 may be incorporated into an electric drive system of an electric vehicle (EV), in one example. As such, the electric motor is a traction motor in such an example and the electric drive may further include a transmission (e.g., gearbox), for instance. In the EV example, the EV may be an all-electric vehicle (e.g., a battery electric vehicle (BEV)), in one example, or a hybrid electric vehicle (HEV) with an internal combustion engine, in another example. However, the motor may be used in other suitable systems (e.g., stationary systems), in other examples, such as in industrial machines, agricultural systems, mining systems, and the like.

The electric motor 100 includes a rotor 104 that electromagnetically interacts with a stator 106 to drive rotation of a rotor shaft 108 of the rotor 104. The electric motor 100 in the illustrated example includes a housing 110 with an electrical interface 112 for the stator 106. The electrical interface 112 may be a multi-phase electrical interface with multiple electrical connectors 114. The electrical interface 112 is a three-phase interface, in the illustrated example. However, it will be understood that the electrical interface may be a six phase interface or a nine phase interface, in other examples. More generally, the electric motor 100 may be a multi-phase alternating current (AC) machine. However, in other examples, the electric motor 100 may be a direct current (DC) machine.

As illustrated in FIG. 1, the electric motor 100 may be electrically coupled to an inverter 116. The inverter 116 is designed to covert direct current (DC) power to alternating current (AC) power and vice versa. As such, the electric motor 100 may be an AC electric motor, as indicated above. However, in other examples, the electric motor 100 may be a DC electric motor (as previously indicated) and the inverter 116 may therefore be omitted from the system 102. The inverter 116 may receive electric energy from one or more energy storage device(s) 118 (e.g., traction batteries, capacitors, combinations thereof, and the like). Arrows 120 signify the electric energy transfer between the electric motor 100, the inverter 116, and the energy storage device(s) 118 that may occur during different modes of system operation.

The system 102 may additionally include a control sub-system 180 with a controller 182. The controller 182 includes a processor 184 and memory 186. The memory 186 may hold instructions stored therein that when executed by the processor 184 cause the controller 182 to perform the various methods, control techniques, and the like. The processor 184 may include a microprocessor unit and/or other types of circuits. The memory 186 may include known data storage mediums such as random access memory, read-only memory, keep alive memory, combinations thereof, and the like.

The controller 182 may receive various signals from sensors 188 positioned in different locations in the system 102. The sensors 188 may include an electric machine speed sensor, energy storage device temperature sensor(s), an energy storage device state of charge sensor(s), an inverter power sensor, and the like. The controller 182 may also send control signals to various actuators 190 coupled at different locations in the system 102. For instance, the controller may send signals to the inverter 116 to adjust the rotational speed of the electric motor 100. In another example, the controller 182 may send a command signal to the electric motor 100 and/or the inverter 116 and in response, motor speed (e.g., rotational speed of the rotor shaft 108) may be adjusted. The other controllable components in the system 102 may function in a similar manner with regard to command signals and actuator adjustment.

The system 102 may also include one or more input device(s) 192 (e.g., an accelerator pedal, a brake pedal, a console instrument panel, a touch interface, a touch panel, a keyboard, combinations thereof, and the like). The input device(s) 192, responsive to user input, may generate a motor speed adjustment request.

A cutting plane 2-2 for a cross-sectional view depicted in FIG. 2 is provided in FIG. 1. The cutting plane 2-2 extends through the motor's rotational axis 199. Turning to FIG. 2, a cross-sectional view of the electric motor 100, including a cooling system 200 and a stator sealing system 290 thereof, is shown. The rotor 104 and the stator 106 of the electric motor 100 are again depicted along with the housing 110 that at least partially encloses the rotor 104 and the stator 106. The housing 110 may comprise one or more parts. For example, a first part 211 may surround the stator 106, and a second part 209 may surround the rotor 104. For examples where the housing 110 comprises more than one part, the parts may be fixed to each other via fasteners 246 (e.g., bolts, screws, rivets, etc.).

The cooling system 200 may be outside of the housing 110, in one example. The cooling system 200 may include a pump 202 and a filter 204 to deliver a coolant (e.g., oil such as a natural and/or synthetic oil) into the stator 106. Arrows 205 depict the flow of coolant between the pump 202, the filter 204, and the cooling system 200. To elaborate, the pump 202 may deliver coolant to flow passages 206 that axially traverse stator core 208, in one example. However, other coolant flow patterns may be used in other examples. The pump 202 and the filter 204 are schematically depicted. However, it will be understood that they may have greater complexity, in practice. Further, the pump 202 and the filter 204 may be spaced away from the electric motor 100.

The stator sealing system 290 may be positioned within the housing 110 and adapted to seal pathways of coolant fluid delivered by the cooling system 200 through the electric motor 100. The stator sealing system 290 may form an air gap 210 between a rotor core 212 of the rotor 104 and the stator core 208 of the stator 106. Due to the coolant fluid (e.g., oil) in the cooling system 200 being sealed from the air gap 210 by the stator sealing system 290 expanded upon herein, the likelihood of coolant entering the air gap 210 is significantly reduced (e.g., avoided).

The stator core 208 may comprise a plurality of lamination layers 298 held (e.g., bonded) together in a stack. For example, the lamination layers 298 may be bonded together by a lamination bonding agent applied in between adjacent lamination layers. Turning to FIG. 6, one of the plurality of lamination layers 298 is shown. Each lamination layer 298 may be formed of a metal, such as steel. The plurality of lamination layers 298 may each have substantially the same thin annular shape with an outer edge 602 having outer diameter 608 and an inner edge 604 having a bore diameter 606 forming a central hole 614. In other embodiments, lamination layers 298 may have different shapes from each other.

Lamination layers 298 may also include a plurality of radially arranged holes 610. The holes 610 may include radially inner holes 610a positioned closer to the inner edge 604 and radially outer holes 610b positioned closer to the outer edge 602. The radially inner holes 610a may have a rectangular shape as shown with longer sides of the rectangle shapes parallel with radial directions. In other embodiments, the holes 610a may be circular, elliptical, square, triangular, or other appropriate shape. The radially inner holes 610a may be positioned closer to inner edge 604 than outer edge 602, without contacting outer edge 602 or inner edge 604. Additionally, the radially inner holes 610a may be evenly spaced apart from one another, in some examples. That is, the radially inner holes 610a may be evenly radially arranged around the inner edge 604. Likewise, the radially outer holes 610b may be evenly radially arranged. The radially outer holes 610b may be smaller than the radially inner holes 610a. For example, the radially outer holes 610b may be square as shown, although other shapes are possible. In some examples, the numbers of radially inner holes 610a and radially outer holes 610b may be equal. In other examples, there may be more or fewer radially inner holes 610a than radially outer holes 610b.

Perimeters of the lamination layers 298 may axially align to form a tube (e.g., stator core 208 of FIG. 2) with an inner cylindrical surface defined by inner edges 604 having bore diameter 606 and an outer cylindrical surface defined by outer edges 602 having outer diameter 608. A hollow part of the tube (e.g., the bore 292 of the stator core 208) may form part of a rotor cavity (e.g., rotor cavity 227 of FIG. 2). As such, the bore diameter 606 may be large enough to accommodate a rotor (e.g., rotor 104 of FIG. 2) with an air gap (e.g., air gap 210 of FIG. 2) between the rotor and lamination layers 298. Additionally, the holes 610 of each lamination layer 298 may axially align to form axially extending passages (e.g., flow passages 206 of FIG. 2 and/or stator winding paths) through the length of the stator core. For example, the radially inner holes 610a may axially align to allow stator windings 228 to extend therethrough. Additionally or alternatively, the radially outer holes 610b may axially align to form the flow passages 206. The holes 610 being spaced evenly around the lamination layers 298 may allow for even cooling of the stator core formed by the lamination layers 298.

The lamination layers 298 as shown in FIG. 6 may be a non-limiting example of lamination layers that form a stator core (e.g., stator core 208 of FIG. 2). In other embodiments, other shapes of lamination layers may be used to form stator core 208. For example, the shape of lamination layers may not be circular. In another example, lamination layers may include additional holes, and/or other features such as grooves, teeth, notches, and the like. In some examples, the lamination layers may include more or fewer holes than depicted in FIG. 6. Additionally, or alternatively, the holes may be a different shape. In some examples, the holes may not be a uniform shape. For example, some holes may be larger and/or a different shape than others. In some examples, there may be more than one concentric circle of radially arranged holes. For example, there may be a first ring of radially arranged holes that axially align to form winding passages wherethrough stator windings axially traverse the stator core as described further below, and a second ring of radially arranged holes that axially align to form flow passages wherethrough coolant fluid axially traverses the stator core. Alternatively, there may be a single ring of holes as shown, with both windings and coolant fluid sharing the holes, for example. Adjusting the hole geometry and spacing in lamination layers 298 may allow for control over the flow pattern of coolant through flow passages in a stator (e.g., flow passages 206 of stator 106 in FIG. 2).

Returning to FIG. 2, in addition to the stator core 208 comprising the plurality of lamination layers 298 as described above, the stator 106 further includes stator windings 228. The stator windings 228 may extend axially from a first axial side 218 of stator 106 to a second axial side 258 of stator 106. The first axial side 218 may be a crown side and second axial side 258 may be a weld side, in one example. More specifically, the stator windings 228 may extend beyond the first axial side 218 of stator core 208 and beyond the second axial side 258 of stator core 208. In some examples, the stator windings 228 may be arranged radially between stator core 208 and air gap 210. In other examples, the stator windings 228 may extend through the lamination layers 298 of the stator core 208 (e.g., through some or all of the holes 610). Ends of the stator windings 228 (e.g., portions of the stator windings 228 axially beyond the stator core 208) may be positioned in a sealed cavity 226 containing coolant fluid.

The stator sealing system 290 may include a first bend lamination layer 400 and a second bend lamination layer 401. FIGS. 4A and 4B depict different views of bend lamination layer 400. Specifically, FIGS. 4A and 4B show a side view and a perspective view, respectively, of the bend lamination layer 400. The second bend lamination layer 401 may be identical to the first bend lamination layer 400.

The bend lamination layer 400 may comprise a base 402 with a plurality of radially arranged holes 410, radially distributed around the base 402. The bend lamination layer 400 may further comprise a protruding portion 404 protruding axially (e.g., in a y-direction according to reference axes 150) from the base 402.

Base 402 may have an outer diameter 408 and a central hole 414 with bore diameter 406. In some examples, base 402 may have substantially the same shape as one of the plurality of lamination layers 298 as shown in FIG. 6. For example, the bore diameter 406 may be the same as bore diameter 606 of the plurality of lamination layers 298 as shown in FIG. 6. Likewise, the outer diameter 408 may be equivalent to the outer diameter 608 of FIG. 6. In other examples, the bore diameter 406 may be larger or smaller than the bore diameter 606 of FIG. 6 and/or the outer diameter 408 may be larger or smaller than the outer diameter 608 of FIG. 6. Additionally, the holes 410 may be similar to the holes 610 of FIG. 6 so as to allow axial alignment therewith. Specifically, a number of the plurality of holes 410 may be the same as a number of the plurality of holes 610 of lamination layers 298 shown in FIG. 6. The geometry and positions of holes 410 may also resemble or be substantially the same as the geometry and positions of holes 610 of lamination layers 298 shown in FIG. 6. Thus, the holes 410 may include radially inner holes 410a configured to axially align with the radially inner holes 610a of FIG. 6, and radially outer holes 410b configured to axially align with the radially outer holes 610b of FIG. 6. In this way, the holes 410 may axially overlap with the holes 610 when the lamination layers 298 and the bend lamination layer 400 are stacked together. Thus, the holes 410 may also define (e.g., circumferentially surround) the coolant passages 206 and stator winding passages extending through the stator core 208 as shown in FIG. 2.

As shown in FIG. 4B, the protruding portion 404 may be a cylinder shape with an inner diameter equivalent to the bore diameter 406. The protruding portion 404 may protrude from base 402 in an axial direction (e.g., positive y-direction) with length 412. The protruding portion 404 may form a bend angle 416 with the base 402 of bend lamination layer 400. In some embodiments, the bend angle 416 may be approximately 90 degrees. Therefore, the protruding portion 404 may protrude perpendicularly from the base 402 (e.g., normal to the base 402). In other embodiments, the bend angle 416 may be a different angle than 90 degrees. In such an example, the protruding portion 404 may be cone shaped, rather than cylindrical. In some embodiments, a first thickness of the base 402 may be substantially the same as a second thickness of the protruding portion 404. In some embodiments, the protruding portion 404 may be formed integrally with the base 402. Alternatively, the protruding portion 404 may be permanently and sealably fixed to the base 402, such as by welding or soldering around the perimeter of the central hole 414 and the protruding portion 404. In this way, fluid may not pass through the interface where the protruding portion 404 and base 402 meet.

Returning to FIG. 2, the second bend lamination layer 401 of FIG. 2 may be substantially the same shape as bend lamination layer 400. That is, the second bend lamination layer 401 may include a base 403, a protruding portion 405, and holes 411, with approximately the same dimensions, shapes, relative positions, etc. as the base 402, the protruding portion 404, and the holes 410. However, the first and second bend lamination layers 400, 401 may be oriented opposite one another when assembled with the stator core 208. For example, the protruding portions 404, 405 may extend opposite one another. Specifically, the protruding portions 404, 405 may extend away from the stator core 208. In other embodiments, bend lamination layers 400, 401 may be different sizes and/or shapes. For example, according to the geometry of the sealed cavity 226, such as examples where the sealed cavity 226 is asymmetrical, the length by which the protruding portions 404, 405 protrude from the respective bases 402, 403 (e.g., the length 412 of FIG. 4B) or other dimensions may be different for the first and second bend lamination layers 400, 401.

The bend lamination layers 400, 401 may be held (e.g., bonded) to the plurality of lamination layers 298 by the lamination bonding agent discussed above, or otherwise bonded to and/or formed as integral to the stator core 208. More specifically, the first bend lamination layer 400 may be bonded to a lamination layer on first axial side 218 of stator 106, oriented such that base 402 may be bonded in face-sharing contact with one of the lamination layers 298 and protruding portion 404 may extend axially in a first direction (e.g., in a positive y-direction) from the stator core 208. Similarly, the second bend lamination layer 401 may be bonded in face-sharing contact with a lamination layer on second axial side 258, oriented such that base 403 may be bonded in face-sharing contact with one of the lamination layers 298 and cylindrical protruding portion 405 may extend axially in a second direction (e.g., in a negative y-direction) from the stator core 208.

Further, the radially arranged holes of the first bend lamination layer 400 (e.g., holes 410), the radially arranged holes of the second bend lamination layer 401 (e.g., holes 411), and the radially arranged holes of the plurality of lamination layers 298 (e.g., holes 610) may axially align. In this way, the flow passages 206 may be formed by axially aligned holes in the first bend lamination layer 400, the second bend lamination layer 401, and the plurality of lamination layers 298. Thus, the holes (e.g., holes 410, 411, and 610) of the lamination layers (e.g., lamination layers 298, 400, and 401) may define the geometry and arrangement of flow passages 206. Further, the holes may direct coolant fluid flow patterns. Therefore, altering the geometry and arrangement of the holes may adjust coolant flow pathways.

Additionally, the central hole of the first bend lamination layer 400 (e.g., central hole 414 of FIGS. 4A and 4B) and the central hole of the second bend lamination layer 401 may axially align with the central holes of the plurality of lamination layers 298 (e.g., central hole 614 of FIG. 6) to form bore 292 of the stator core 208. The central holes of the lamination layers 298 and the bend lamination layers 400, 401 may define the rotor cavity 227 where the rotor 104 is positioned. Thus, a length of bore 292 (e.g., length of the inner surface of the stator 106 that circumferentially surrounds the rotor cavity 227) may be the sum of axial length 295 of the stator core 208, the length of the protruding portion 404 of the first bend lamination layer 400 (e.g., length 412 of FIG. 4B), and the length of the protruding portion 405 of the second bend lamination layer 401 (which may be equal to the length 412 of FIG. 4B). In this way, the axial length of the bore 292 may be increased beyond the lamination layers 298 by modifying the lamination layers on both ends to include the protruding portions 404, 405. Such a configuration may provide sealing interfaces for sealing rings to seal the rotor cavity 227 more effectively than other sealing ring positions, as described further below.

The rotor core 212 may be positioned within the bore 292 of the stator 106 formed by the plurality of lamination layers 298, first bend lamination layer 400, and second bend lamination layer 401. The rotor core 212 may be circumferentially surrounded by the lamination layers 298. A rotor axial length 296 of the rotor core 212 may be approximately the same as or less than the stator axial length 295 of the stator core 208. In some examples, the rotor core 212 may extend axially further than shown such that the rotor core 212 is additionally circumferentially surrounded by the bend lamination layers 400, 401, more specifically the protruding portions 404, 405 thereof. In such examples, the axial length 296 of the rotor core 212 may be up to the length of the bore 292 of the stator 106, which is the sum of the lengths of the protruding portions 404, 405 and the stator axial length 295 of the stator core 208.

The air gap 210 may also be contained within the bore 292, such that the air gap 210 circumferentially surrounds the rotor 104, and the stator 106 circumferentially surrounds both the rotor 104 and the air gap 210. The stator sealing system 290 may seal the inside of the bore 292 to from rotor cavity 227. By doing this, the stator sealing system 290 may seal an air-filled compartment (e.g., rotor cavity 227) from a liquid-filled compartment (e.g., sealed cavity 226).

The sealed cavity 226 containing coolant fluid may include a first cavity 236 and a second cavity 237, fluidly coupled via the flow passages 206. The first cavity 236 may be on first axial side 218 of stator 106 and the second cavity 237 may be on second axial side 258 of stator 106. The cavities 236, 237 may be positioned within the housing 110. The first cavity 236 may be configured to hold a first end of stator windings 228 and coolant fluid, such that stator windings 228 may be at least partially immersed in the coolant fluid. Likewise, the second cavity 237 may be configured to hold a second end of stator windings 228 and coolant fluid, such that stator windings 228 may be at least partially immersed in the coolant fluid. The cavities 236, 237 may each be shaped as a modified torus, with cross sections as shown in FIG. 2 rather than circular, and thus the cavities 236, 237 may be radially symmetrical. The rotational axis 199 may extend through axial centers of the cavities 236, 237.

The first cavity 236 may be defined by one or more walls 262 which surround the cavity 236. The walls 262 may meet the endmost lamination layer at the first axial side 218 (e.g., the bend lamination layer 400) at a radially outer position and a radially inner position. A seal may be formed between at the radially inner position (e.g., at sealing interface 270) to prevent fluid from entering the bore 292, as described further below. Additionally, there may be a sealing element 266 at the radially outer position to seal other potential leak pathways out of the sealed cavity 226. In this way, the endmost lamination layer at the first axial side 218 and the walls 262 may seal fluid within the cavity 236, allowing fluid to enter and exit the cavity only via the flow passages 206 and inlets and/or outlets wherethrough coolant travels between the cooling system 200 and the sealed cavity 226.

Likewise, the second cavity 237 may be defined by one or more walls 264 which surround the cavity 237. The walls 264 may meet the endmost lamination layer at the second axial side 258 (e.g., bend lamination layer 401) at a radially outer position and a radially inner position. A seal may be formed between at the radially inner position (e.g., at sealing interface 272) to prevent fluid from entering the bore 292, as described further below. Additionally, there may be a sealing element 268 at the radially outer position to seal other potential leak pathways out of the sealed cavity 226. The sealing element 268 may be identical to the sealing element 266. In this way, the endmost lamination layer at the second axial side 258 and the walls 264 may seal fluid within the cavity 237, allowing fluid to enter and exit the cavity only via the flow passages 206 and inlets and/or outlets wherethrough coolant travels between the cooling system 200 and the sealed cavity 226.

The second cavity 237 may be larger than the first cavity 236, in some examples. For example, the second end of the stator windings 228 (e.g., adjacent to the second axial side 258 of the stator core 208) may be encased in covers 225. The covers 225 may be configured to protect the windings 228 from degradation. For example, the covers 225 may be electrically and/or thermally insulating. The covers 225 may expand the space occupied by the stator windings 228 in the second cavity 237 compared to in the first cavity 236. Thus, the second cavity 237 may be larger to accommodate the covers 225. Therefore, the walls 264 may be configured to enclose a larger space than the walls 262.

The flow passages 206 may extend through the stator core 208 from the first cavity 236 on the first axial side 218 to the second cavity 237 on the second axial side 258. In this way, coolant may axially traverse the stator 106 to enable heat to be effectively removed therefrom. The sealed cavity 226 containing coolant fluid may be fluidly separated from rotor cavity 227 containing air due to the sealing system 290 such that coolant fluid entering the air gap 210, which creates drag losses in the motor 100, can be reduced (e.g., avoided), thereby increasing motor efficiency.

In addition to the bend lamination layers 400, 401, the stator sealing system 290 may further include a first sealing ring 280 and a second sealing ring 282. The sealing rings 280, 282 may be a variety of forms, such as O-rings, gaskets, diamond seals, liquid seals, and/or elastomeric seals. The sealing rings 280, 282 may be substantially the same as each other, in some examples. In other examples, the sealing rings 280, 282 may be different from each other in type, size, and/or shape. The sealing rings 280, 282 may be configured (e.g., sized, shaped, and positioned) according to the protruding portions 404, 405. For example, the sealing rings 280, 282 may have an outer diameter no larger than the bore diameter 406 such that the sealing rings 280, 282 may fit inside the protruding portions 404, 405.

The stator sealing system 290 may include a first sealing interface 270 where the first sealing ring 280 is interposed between a first sealing wall 284 and the first bend lamination layer 400. To elaborate, the first sealing interface 270 may be formed between a radially outward facing surface of the first sealing wall 284 and a radially inward facing surface of the protruding portion 404 (e.g., radially inward facing surface 420 of FIGS. 4A and 4B). The first sealing wall 284 may be integral with the second part 209 of the housing 110 that surrounds the rotor 104. Additionally, or alternatively, the first sealing wall 284 may be integral with one or more of the walls 262 that enclose the first cavity 236. The first sealing ring 280 may be in face-sharing contact with the first bend lamination layer 400 and the first sealing wall 284 at the first sealing interface 270 such that coolant fluid (e.g., oil) may not pass between the first sealing ring 280 and first bend lamination layer 400 or first sealing wall 284 at the first sealing interface 270. The first sealing interface 270 may form a seal (e.g., hermetic seal) to prevent a first pathway of coolant fluid from the second cavity 237 of the sealed cavity 226 into the rotor cavity 227.

Similarly, a second sealing interface 272 may be formed with the second sealing ring 282 interposed between second bend lamination layer 401 and a second sealing wall 286. More specifically, the second sealing ring 282 may be interposed between a radially outward facing surface of the second sealing wall 286 and a radially inward facing surface of the protruding portion 405 (e.g., radially inward facing surface 420 of FIGS. 4A and 4B). The second sealing wall 286 may be integral with the second part 209 of the housing 110 that surrounds the rotor 104. Additionally or alternatively, the second sealing wall 286 may be integral with one or more of the walls 264 that enclose the second cavity 237. The second sealing ring 282 may be in face-sharing contact with the second bend lamination layer 401 and the second sealing wall 286 at the second sealing interface 272 such that coolant fluid may not pass therethrough. Like the first sealing interface 270, the second sealing interface 272 may form a seal (e.g., hermetic seal) to prevent a second pathway of coolant fluid from the second cavity 237 of the sealed cavity 226 into the rotor cavity 227. The first sealing interface 270 and the second sealing interface 272 may be relatively near the first axial side 218 and second axial side 258, respectively.

The sealing interfaces 270, 272 formed by bend lamination layers 400, 401, sealing walls 284, 286, and sealing rings 280, 282 may seal the sealed cavity 226 wherein stator windings 228 are positioned and coolant fluid is contained. Thus, the sealing interfaces 270, 272 may seal each end of the bore 292 wherein the rotor cavity 227 is positioned, preventing fluid drag losses on rotation of the rotor 104. By extending the bore 292 without extending the length 295 (e.g., without adding lamination layers to the stator core 208) via the protruding portions 404, 405, the sealing system 290 may provide more effective sealing locations for the sealing rings 280, 282 while minimizing additional spatial demand. For example, positioning a sealing ring between radially oriented surfaces may form a more effective seal than adhering the sealing ring to an axially facing surface of one of the lamination layers 298, as done in at least some previous examples.

FIG. 3 shows a cross-sectional view of the electric motor 100, the cooling system 200 for the motor, and a second example of a stator sealing system 390. The stator sealing system 390 may include a bore sleeve 500, a first sealing ring 380, and a second sealing ring 382, which may seal an inside of the bore sleeve 500 from fluid. To elaborate, the air gap 210 may be positioned inside the bore sleeve 500 and sealed via the sealing system 390 such that the rotor core 212 is not contacted by coolant fluid flowing in the sealed cavity 226 and flow passages 206. Similar to the bend lamination layers 400, 401 of FIGS. 2, 4A, and 4B, the bore sleeve 500 may extend the length of the bore beyond the length 295 of the stator core 208 to provide sealing interfaces where the first sealing ring 380 and the second sealing ring 382 seal the interior and exterior of the rotor cavity 227.

FIGS. 5A and 5B depict different views of the bore sleeve 500. The bore sleeve 500 may be an open-ended, hollow cylindrical shape. The bore sleeve 500 may be constructed of ceramic and/or metal. The bore sleeve 500 may have an outer diameter 504 and an axial length 502, as shown in FIG. 5A. The axial length 502 may be longer than a length of a stator core (e.g., length 295 of stator core 208 of FIG. 3) such that the bore sleeve 500 protrudes axially beyond the stator core (e.g., in positive and negative y-directions). An outer diameter 504 of the bore sleeve 500 may be less than or equal to a bore diameter of lamination layers surrounding the bore sleeve 500 (e.g., bore diameter 606 of lamination layers 298 in FIG. 6). Dimensions of the bore sleeve 500 may also include a thickness 506 and an inner diameter 508, as shown in FIG. 5B. The inner diameter 508 may be large enough to accommodate a rotor (e.g., rotor 104 of FIG. 3) with an air gap (e.g., air gap 210 of FIG. 3) between the rotor and the bore sleeve 500. In other embodiments, the bore sleeve 500 may have an elliptical or other shaped cross-section rather than circular, or other suitable shape according to stator lamination layer design.

Returning to FIG. 3, the bore sleeve 500 may be positioned within the bore 292 formed by the plurality of lamination layers 298. The bore sleeve 500 may be positioned such that the rotational axis 199 extends axially through the center of the bore sleeve 500. In some examples, the bore sleeve 500 may be sized to be in face-sharing contact with the plurality of lamination layers 298 (e.g., with outer diameter 504 equal to the bore diameter 606). In other examples, the bore sleeve 500 may be radially spaced away from the stator core 208 (e.g., with outer diameter 504 smaller than the bore diameter 606). The stator windings 228 may circumferentially surround the bore sleeve 500. Ends of the stator windings 228 may further be positioned in the cavities 236, 237 of sealed cavity 226 as described above with respect to FIG. 2.

The rotor core 212 may be positioned within the bore sleeve 500. The air gap 210 may be interposed between the rotor core 212 and the bore sleeve 500. Thus, the bore sleeve 500 may circumferentially surround the air gap 210 and the rotor core 212. Further, the stator core 208 may circumferentially surround the bore sleeve 500. Like the sealing system 290 described above, the sealing system 390 may maintain the air gap 210 by sealing the rotor cavity 227 from fluid contained in the sealed cavity 226.

In addition to the bore sleeve 500, the stator sealing system 390 may further include a first sealing ring 380 and a second sealing ring 382. Similar to the sealing rings 280, 282 of FIG. 2, the sealing rings 380, 382 may be a variety of forms, such as O-rings, gaskets, diamond seals, liquid seals, and/or elastomeric seals. The sealing rings 380, 382 may be substantially the same as each other. In other examples, the sealing rings 380, 382 may be different from each other in type, size, and/or shape. The sealing rings 380, 382 may have an outer diameter smaller than or equal to an inner diameter of the bore sleeve 500 (e.g., diameter 508 of FIG. 5B), such that the sealing rings may fit inside the bore sleeve 500. Thus, the sealing rings 380, 382 may be smaller in diameter than the sealing rings 280, 282 of the sealing system 290 due to the inner diameter 508 being smaller than the bore diameter 606 of the bore 292.

Similar to the protruding portions 404, 405 of the stator sealing system 290 described above, the ends of the bore sleeve 500 may protrude axially beyond the lamination layers 298. In this way, the bore sleeve 500 may effectively extend the bore 292 without extending the length 295 of the stack of lamination layers 298, providing sealing locations where sealing rings may be positioned to form more effective seals than can be formed by convention sealing methods such as adhering sealing rings to sides of the lamination layers. Rather than adapting end lamination layers to provide the sealing locations for sealing rings 280, 282 via extensions integral with the lamination layers as in the sealing system 290 (e.g., protruding portions 404, 405), the addition of the bore sleeve 500 in the sealing system 390 achieves the same effect of providing the sealing locations without modifying lamination layers of a conventional stator core.

For example, a first sealing interface 370 may be formed between first sealing ring 380 and the bore sleeve 500 on an inside of the bore sleeve 500 near first axial side 218 of stator core 208, wherein the first sealing ring 380 may be in face-sharing contact with the bore sleeve 500 at the first sealing interface 370 such that fluid may not pass between the first sealing ring 380 and the bore sleeve 500 at the first sealing interface 370. Similarly, a second sealing interface 372 may be formed between second sealing ring 382 and the bore sleeve 500 on an inside of the bore sleeve 500 near second axial side 258 of stator core 208, wherein the second sealing ring 382 may be in face-sharing contact with the bore sleeve 500 at the second sealing interface 372 such that fluid may not pass between the second sealing ring 382 and the bore sleeve 500 at the second sealing interface 372. The sealing interfaces 370, 372 formed by the bore sleeve 500 and sealing rings 380, 382 may seal the sealed cavity 226 in which the stator windings 228 are positioned and coolant fluid is contained. The sealing interfaces 370, 372 may also prevent fluid from entering the rotor cavity 227.

The sealing system 390 may further include support rings physically coupled to the bore sleeve 500 and configured to mechanically support and position the bore sleeve 500 relative to the lamination layers 298. For example, turning to FIG. 7, a first support ring 702 and a second support ring 704 are shown physically coupled to the bore sleeve 500.

The first support ring 702 and the second support ring 704 may be positioned in proximity to a first end and a second end axially opposite the first end, respectively, of the bore sleeve 500. The support rings 702, 704 may be positioned a distance 706 from the respective ends. Additionally, the support rings 702, 704 may be positioned a distance 708 apart from one another, where the distance 708 is shorter than the axial length 502 of the bore sleeve 500. The support rings 702, 704 may be annular in shape, and may circumferentially surround the bore sleeve 500. Further, radially inward facing surfaces of the support rings 702, 704 may be in face-sharing contact with radially outward facing surface 710 of the bore sleeve 500. Thus, the inner diameter of the support rings 702, 704 may be the same as the outer diameter 504 of the bore sleeve 500.

The support rings 702, 704 may be further shaped, positioned, and sized according to the lamination layers (e.g., lamination layers 298). For example, x-z cross sections of the support rings 702, 704 may be the same size and shape as the lamination layers. The lamination layers may be interposed between and in face-sharing contact with the support rings 702, 704. Thus, the distance 708 may be approximately the same as the axial length 295 of the stator core 208 shown in FIG. 3. Additionally, an outer diameter 712 of the support rings 702, 704 may be approximately equal to the diameter 408 of FIG. 4A. Further, the support rings 702, 704, may include radially arranged holes 716 positioned and shaped the same as holes in the lamination layers (e.g., holes 410). For example, there may be an inner ring of radially arranged holes (e.g., radially inner holes 716a) and an outer ring of radially arranged holes (e.g., radially outer holes 716b). The radially inner holes 716a may axially align with the radially inner holes 410a of FIG. 4 and the radially inner holes 610a of FIG. The radially outer holes 716b may axially align with the radially outer holes 410b of FIG. 4 and the radially outer holes 610b of FIG. 6. In such an example, the radially inner holes 716a may receive stator windings. Additionally, fluid may flow through the radially outer holes 716b. In this way, the holes of the support rings 702, 704 and the lamination layers may axially align such that the support rings 702, 704 may extend rather than obstruct the flow passages 206 and winding passages wherethrough the coolant fluid and windings 228 of FIG. 3 may axially traverse the stator core. In other examples, there may be a different number or arrangement of the holes 716, according to the design of the lamination layers, winding configuration, and/or desired flow patterns.

The support rings 702, 704 may not be identical to the lamination layers. For example, a thickness 714 and/or material of the support rings 702, 704 may differ from the lamination layers. For examples where the lamination layers are radially spaced away from the bore sleeve 500, the inner diameter of the lamination layers (which is larger than the outer diameter of the bore sleeve 500 in such an example) may be larger than the inner diameter of the support rings 702, 704 (which is approximately equal to the outer diameter 504 of the bore sleeve 500).

Further, the support rings 702, 704 may include various surface features on axially outer surfaces 720 (e.g., surfaces facing axially away from each other). For example, edges 722 of the radially inner holes 716a may be rounded at the intersection with the axially outer surfaces 720. Rounding the edges 722 may reduce degradation to windings extending through the corresponding holes 716. Similarly, an outer edge 726 intersecting the outer perimeter of the axially outer surfaces 720 may be rounded. Additionally or alternatively, a raised bead 724 may surround the perimeter of each of the radially outer holes 716b. The raised beads 724 may support desired fluid flow patterns into and/or out of the radially outer holes 716b, for example. Axially inner surfaces 718 of the support rings 702, 704 (e.g., surfaces facing axially towards each other) may be flat with sharp edges (e.g., corners at the perimeters of the holes 716 and the outer perimeters of the support rings) such that the axially inner surfaces 718 may be positioned flush with the flat lamination layers. In this way, the support rings 702, 704 may be identical and oriented as mirror images on one another.

Turning to FIG. 8, part of the electric motor 100 is shown with the stator sealing system 390 including the support rings 702, 704. Some components of the electric motor 100 are omitted from FIG. 8 (e.g., stator windings 228) or shown schematically (e.g., lamination layers 298) for visual clarity. The support rings 702, 704 may be coaxially stacked in face-sharing contact with the lamination layers 298, as shown. By doing this, and physically coupling the bore sleeve 500 with the support rings 702, 704 in the way described above, the bore sleeve 500 may be positioned relative to the lamination layers 298 and mechanically stabilized via the support rings 702, 704.

The sealing interfaces 370, 372 are again shown in FIG. 8 where the sealing rings 380, 382 seal the interior of the bore sleeve 500 from the sealed cavity 226. As described above, the sealing rings 380, 382 may be interposed between the radially inward facing surface of the bore sleeve 500 and the respective sealing walls 284, 286. The sealing walls 284, 286 may be integral with the walls enclosing the sealed cavity 226. Further, one or more of the sealing walls 284, 286 may include a ridge 802 configured to axially position the bore sleeve 500 relative thereto. For example, the ridge 802 may protrude radially outward, providing a barrier to the bore sleeve 500 extending axially further than the ridge 802. Thus, by positioning the ridge 802 where an end of the bore sleeve 500 is desired to reach, the bore sleeve 500 can be pushed (e.g., from right to left) towards the ridge 802 until stopped by contact therewith. Additionally or alternatively, the ridge 802 may provide axial support during operation of the motor 100 to prevent axial shifting of the bore sleeve 500.

The sealing rings 380, 382 may be positioned anywhere along the radially inward facing surface of the bore sleeve 500 that also allows face-sharing contact with the sealing walls 284, 286. That is, the axial positions of the sealing rings 380, 382 may be positioned at a region where the bore sleeve 500 and the respective sealing walls 284, 286 overlap. For example, the sealing rings 380, 382 may be radially aligned with the support rings 702, 704 such that the support rings 702, 704 circumferentially surround the sealing rings 380, 382. In another example, the sealing rings 380, 382 may be offset from the support rings 702, 704, either closer to the lamination layers 298 or the respective ends of the bore sleeve 500. The support rings 702, 704 may provide physical support against pressure applied to the bore sleeve 500 by the sealing rings 380, 382. The sealing walls 284, 286 may include indents adapted to receive the sealing rings 380, 382, in some examples, to ensure the sealing rings 380, 382 are positioned where desired.

By effectively extending the bore 292 without extending the length 295 (e.g., without adding lamination layers to the stator core 208) via the bore sleeve 500 protruding axially beyond the stator core 208 on both ends, the sealing system 390 may provide more effective sealing locations for the sealing rings 380, 382. For example, positioning a sealing ring between radially oriented surfaces may form a more effective seal (e.g., less leak-prone) than positioning the sealing ring on an axially facing surface of the lamination layers 298 or positioning the sealing ring directly onto inner edges of the lamination layers 298, as done in at least some previous examples, due to an inadequate sealing surface (e.g., smaller available surface area, surface texture, etc.). Thus, providing the sealing surfaces on the bore sleeve 500 may reduce (e.g., avoid) coolant leaks into the interior of the bore sleeve 500 where the rotor 104 is positioned.

In some examples, the support rings 702, 704 may be positioned similarly in systems including the bend lamination layers 400, 401, such as the example of the electric motor 100 shown in FIG. 2. For example, the support rings 702, 704 may circumferentially surround the protruding portions 404, 405 to provide support against pressure applied to the bend lamination layers 400, 401 by the sealing rings 280, 282.

The technical effect of the stator assembly, which includes a stator sealing system, of an electric motor described herein is to increase efficiency of the motor by preventing coolant fluid from causing drag losses due to reaching an air gap between a rotor and the stator. The sealing system may include a bore sleeve or bend lamination layers which extend the bore of the stator without adding lamination layers to provide sealing interfaces where sealing rings may be positioned to seal the rotor cavity wherein the rotor is located from a sealed cavity wherein coolant fluid flows. In this way, a more effective seal may be formed than previous stator sealing configurations, reducing (e.g., preventing) fluid crossing over the sealing interfaces from the sealed cavity to the rotor cavity. Thus, the motor comprising the stator sealing system disclosed herein may have increased efficiency.

The disclosure also provides support for a stator sealing system for a stator of an electric motor, comprising: a first bend lamination layer positioned at a first axial side of lamination layers of the stator, a second bend lamination layer positioned at a second axial side of the lamination layers, the second axial side being axially opposite the first axial side, wherein the first bend lamination layer and the second bend lamination layer each include a cylindrical protruding portion extending perpendicularly from a base, and a first sealing ring and a second sealing ring, wherein the first sealing ring is in face-sharing contact with a radially inward facing surface of the protruding portion of the first bend lamination layer and the second sealing ring is in face-sharing contact with a radially inward facing surface of the protruding portion of the second bend lamination layer such that the first sealing ring, the second sealing ring, the first bend lamination layer, and the second bend lamination layer seal a bore circumferentially surrounded by the lamination layers from fluid. In a first example of the system, the first sealing ring is further in face-sharing contact with a radially outward facing surface of a first sealing wall and the second sealing ring is further in face-sharing contact with a radially outward facing surface of a second sealing wall, and the first sealing wall and the second sealing wall are integral with walls that enclose a sealed cavity of the electric motor containing coolant fluid. In a second example of the system, optionally including the first example, the base and the lamination layers include radially arranged holes that axially align to form flow passages through the stator. In a third example of the system, optionally including one or both of the first and second examples, the first sealing ring and the second sealing ring are O-rings. In a fourth example of the system, optionally including one or more or each of the first through third examples, the protruding portion extends from an inner edge of the base. In a fifth example of the system, optionally including one or more or each of the first through fourth examples, the protruding portion of the first bend lamination layer extends from the base of the first bend lamination layer in a first direction and the protruding portion of the second bend lamination layer extends from the base of the second bend lamination layer in a second direction, the first direction axially opposite the second direction. In a sixth example of the system, optionally including one or more or each of the first through fifth examples, the protruding portion is integrally formed with the base. In a seventh example of the system, optionally including one or more or each of the first through sixth examples, a shape of the first bend lamination layer is substantially the same as the second bend lamination layer. In a eighth example of the system, optionally including one or more or each of the first through seventh examples, diameters of the protruding portion and the bore are approximately the same. In a ninth example of the system, optionally including one or more or each of the first through eighth examples, outer diameters of the base and the lamination layers are approximately the same.

The disclosure also provides support for a stator assembly, comprising: a stator core including a plurality of lamination layers circumferentially surrounding a bore, a cylindrical bore sleeve extending axially through the bore, the bore sleeve having a longer axial length than the stator core such that the bore sleeve protrudes from the stator core at a first axial side of the stator core and a second axial side of the stator core axially opposite the first axial side, a first support ring and a second support ring circumferentially surrounding the bore sleeve and positioned at the first axial side and the second axial side, respectively, and a first sealing ring and a second sealing ring in face-sharing contact with the bore sleeve, wherein the first sealing ring and the second sealing ring seal an inside of the bore sleeve from fluid. In a first example of the system, the first sealing ring and the second sealing ring are further in face-sharing contact with walls enclosing a sealed cavity containing coolant fluid. In a second example of the system, optionally including the first example, the bore sleeve is in face-sharing contact with the plurality of lamination layers. In a third example of the system, optionally including one or both of the first and second examples, stator windings axially traversing the stator core are positioned radially around an outside of the bore sleeve. In a fourth example of the system, optionally including one or more or each of the first through third examples, the system further comprises: flow passages formed by axially aligned holes in the plurality of lamination layers, wherein coolant fluid axially traverses the plurality of lamination layers through the flow passages.

The disclosure also provides support for an electric motor, comprising: a rotor, a stator including a stack of lamination layers circumferentially surrounding the rotor and windings extending through the lamination layers, a cylindrical bore sleeve radially interposed between the stator and the rotor, wherein the bore sleeve is longer than an axial length of the stack of lamination layers, a first cavity at a first axial side of the stator and a second cavity at a second axial side of the stator, and a first sealing ring and a second sealing ring in face-sharing contact with a radially inward facing surface of the bore sleeve. In a first example of the system, the first sealing ring and the second sealing ring are further in face-sharing contact with radially outward facing surfaces of walls that enclose the first cavity and the second cavity, respectively. In a second example of the system, optionally including the first example, the system further comprises: a first support ring interposed between the first cavity and the lamination layers, and a second support ring interposed between the second cavity and the lamination layers, wherein the first support ring and the second support ring circumferentially surround and physically couple to the bore sleeve. In a third example of the system, optionally including one or both of the first and second examples, ends of the windings are positioned in the first cavity and the second cavity. In a fourth example of the system, optionally including one or more or each of the first through third examples, the system further comprises: flow passages that fluidly couple the first cavity and the second cavity, wherein coolant fluid axially traverses the stator through the flow passages.

FIGS. 2-8 are drawn approximately to scale, aside from the schematically depicted components. However, the components may have other relative dimensions, in other embodiments. FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such.

Note that the example control and estimation routines included herein can be used with various motor configurations. The control methods and routines disclosed herein may be stored as executable instructions in non-transitory memory and may be carried out by the control system including the controller in combination with the various sensors, actuators, and other electric drive and/or vehicle hardware in combination with the electronic controller. As such, the described actions, operations, and/or functions may graphically represent code to be programmed into non-transitory memory of the computer readable storage medium in the vehicle and/or driveline control system. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A stator sealing system for a stator of an electric motor, comprising:
a first bend lamination layer positioned at a first axial side of lamination layers of the stator;
a second bend lamination layer positioned at a second axial side of the lamination layers, the second axial side being axially opposite the first axial side, wherein the first bend lamination layer and the second bend lamination layer each include a cylindrical protruding portion extending perpendicularly from a base; and
a first sealing ring and a second sealing ring, wherein the first sealing ring is in face-sharing contact with a radially inward facing surface of the protruding portion of the first bend lamination layer and the second sealing ring is in face-sharing contact with a radially inward facing surface of the protruding portion of the second bend lamination layer such that the first sealing ring, the second sealing ring, the first bend lamination layer, and the second bend lamination layer seal a bore circumferentially surrounded by the lamination layers from fluid.

2. The stator sealing system of claim 1, wherein the first sealing ring is further in face-sharing contact with a radially outward facing surface of a first sealing wall and the second sealing ring is further in face-sharing contact with a radially outward facing surface of a second sealing wall, and the first sealing wall and the second sealing wall are integral with walls that enclose a sealed cavity of the electric motor containing coolant fluid.

3. The stator sealing system of claim 1, wherein the base and the lamination layers include radially arranged holes that axially align to form flow passages through the stator.

4. The stator sealing system of claim 1, wherein the first sealing ring and the second sealing ring are O-rings.

5. The stator sealing system of claim 1, wherein the protruding portion extends from an inner edge of the base.

6. The stator sealing system of claim 1, wherein the protruding portion of the first bend lamination layer extends from the base of the first bend lamination layer in a first direction and the protruding portion of the second bend lamination layer extends from the base of the second bend lamination layer in a second direction, the first direction axially opposite the second direction.

7. The stator sealing system of claim 1, wherein the protruding portion is integrally formed with the base.

8. The stator sealing system of claim 1, wherein a shape of the first bend lamination layer is substantially the same as the second bend lamination layer.

9. The stator sealing system of claim 1, wherein diameters of the protruding portion and the bore are approximately the same.

10. The stator sealing system of claim 1, wherein outer diameters of the base and the lamination layers are approximately the same.

11. A stator assembly, comprising:
a stator core including a plurality of lamination layers circumferentially surrounding a bore;
a cylindrical bore sleeve extending axially through the bore, the bore sleeve having a longer axial length than the stator core such that the bore sleeve protrudes from the stator core at a first axial side of the stator core and a second axial side of the stator core axially opposite the first axial side;
a first support ring and a second support ring circumferentially surrounding the bore sleeve and positioned at the first axial side and the second axial side, respectively; and
a first sealing ring and a second sealing ring in face-sharing contact with the bore sleeve, wherein the first sealing ring and the second sealing ring seal an inside of the bore sleeve from fluid.

12. The stator assembly of claim 11, wherein the first sealing ring and the second sealing ring are further in face-sharing contact with walls enclosing a sealed cavity containing coolant fluid.

13. The stator assembly of claim 11, wherein the bore sleeve is in face-sharing contact with the plurality of lamination layers.

14. The stator assembly of claim 11, wherein stator windings axially traversing the stator core are positioned radially around an outside of the bore sleeve.

15. The stator assembly of claim 11, further comprising flow passages formed by axially aligned holes in the plurality of lamination layers, wherein coolant fluid axially traverses the plurality of lamination layers through the flow passages.

16. An electric motor, comprising:
a rotor;
a stator including a stack of lamination layers circumferentially surrounding the rotor and windings extending through the lamination layers;
a cylindrical bore sleeve radially interposed between the stator and the rotor, wherein the bore sleeve is longer than an axial length of the stack of lamination layers;
a first cavity at a first axial side of the stator and a second cavity at a second axial side of the stator; and
a first sealing ring and a second sealing ring in face-sharing contact with a radially inward facing surface of the bore sleeve.

17. The electric motor of claim 16, wherein the first sealing ring and the second sealing ring are further in face-sharing contact with radially outward facing surfaces of walls that enclose the first cavity and the second cavity, respectively.

18. The electric motor of claim 16, further comprising a first support ring interposed between the first cavity and the lamination layers, and a second support ring interposed between the second cavity and the lamination layers, wherein the first support ring and the second support ring circumferentially surround and physically couple to the bore sleeve.

19. The electric motor of claim 16, wherein ends of the windings are positioned in the first cavity and the second cavity.

20. The electric motor of claim 16, further comprising flow passages that fluidly couple the first cavity and the second cavity, wherein coolant fluid axially traverses the stator through the flow passages.
